(19) United States
(12) Patent Application Publication
(10) Pub. No.: US 2024/0052459 A1
(43) Pub. Date: Feb. 15, 2024

(54) 600 C/1 GPA HIGH-TEMPERATURE ULTRA-HIGH STRENGTH TI ALLOY AND PREPARATION METHOD THEREFOR

(71) Applicant: DALIAN UNIVERSITY OF TECHNOLOGY, Dalian (CN)

(72) Inventors: Zhihao ZHU, Dalian (CN); Shuang ZHANG, Dalian (CN); Qing WANG, Dalian (CN); Xiaona LI, Dalian (CN); Chuang DONG, Dalian (CN)

(21) Appl. No.: 18/217,770

(22) Filed: Jul. 3, 2023

(30) Foreign Application Priority Data
Aug. 12, 2022 (CN) 202210966390.2

(51) Int. Cl. C22C 14/00; C22C 1/03

(52) U.S. Cl. CPC C22C 14/00; C22C 1/03

(57) ABSTRACT

The present invention relates to a 600° C./1 GPa high-temperature ultra-high strength Ti alloy and a preparation method therefor, and belongs to an alloy system of Ti—Al—Zr—Sn—Si plus refractory metals. The 600° C./1 GPa high-temperature ultra-high strength Ti alloy comprises the following main components by mass percent: 5.2 wt. %-6.0 wt. % of Al, 6.2 wt. %-12.5 wt. % of Zr, 5.8 wt. %-6.5 wt. % of Sn, 0.3 wt. %-1.5 wt. % of Si and the balance of Ti element, refractory metals and other unavoidable impurities. Firstly, an alloy is prepared after incoming materials quality inspection. Secondly, a high-melting point master alloy and a low-melting point Al—Sn master alloy are respectively prefabricated to inhibit the uneven dissolution of elements and improve the microstructure homogeneity. Finally, the alloy blocks are subjected to vacuum arc melting to prepare an alloy. The present invention is convenient for mass production and can be used as an alternative material for high-temperature structural components of cutting-edge aviation and weapon equipment.

### TECHNICAL FIELD

The present invention relates to a 600° C./1 GPa high-temperature ultra-high strength Ti alloy and a preparation method therefor, and belongs to the technical field of high-temperature Ti alloys.

### BACKGROUND

The high-temperature Ti alloy material is a key material in the aerospace industry, mainly used in cutting-edge high-temperature structural components such as aero-engines and aerospace crafts, but the relevant 600° C.-resistant ultra-high strength Ti alloy composition system is extremely deficient. At present, the most commonly used industrial high-temperature Ti alloys mainly include BT36, Ti60, IMI834, Ti1100, Ti600, Ti65, etc., which have the advantage of good creep resistance, but also have the shortcomings of insufficient high-temperature strengths, poor damage tolerance, and ultimate tensile strength lower than 700 MPa at 600° C., seriously restricting the application of high-temperature Ti alloys. Therefore, it is urgently to develop a 600° C./1 GPa high-temperature ultra-high strength Ti alloy.

In the invention CN102329983A, Baoshan Iron & Steel Co., Ltd. proposes a Ti alloy resistant to high temperature above 600° C. The method is mainly to add a large amount of B element, C element and expensive rare-earth element Ce to a Ti—Al—Sn—Zr—Mo—Nb—Ta—Si alloy matrix to form TiB short fibers, TiC particles and rare earth oxides which are not distributed evenly in the alloy, resulting in unstable high-temperature microstructure and performance of the alloy, and the ultimate tensile strength at 600° C. is lower than 820 MPa, which is not convenient for mass production and application.

In the invention CN112195363A, the Institute of Metal Research, Chinese Academy of Sciences proposes a 500-600° C. high-strength Ti alloy and a machining method therefor. The method is mainly to add TiB particles to a Ti—Al—Sn—Zr—Mo—W—Si alloy matrix, and the alloy preparation process includes casting or hot-pressing sintering and repeated upsetting and drawing deformation to obtain a high-temperature Ti alloy. However, the TiB2 particles in the alloy will have agglomeration, resulting in unstable microstructure and performance of the alloy, the material yield is low, and the preparation process is very complicated.

In view of the above problems, by introducing a cluster-plus-glue-atom model describing a chemical short-range-order structure, the composition of mature industrial high-temperature Ti alloys is analyzed, and the short-range-order structural units and corresponding composition formulas of Ti alloys are found, which are the basis for the composition design of high-temperature Ti alloys.

### SUMMARY

The present invention aims to solve the technical problems of insufficient high-temperature strengths, poor plasticity and poor damage tolerance of the existing high-temperature Ti alloys, and designs and develops a 600° C./1 GPa high-temperature ultra-high strength Ti alloy.

To achieve the above purpose, the present invention adopts the following technical solution:

A 600° C./1 GPa high-temperature ultra-high strength Ti alloy, which belongs to an alloy system of Ti—Al—Zr—Sn—Si plus refractory metals and comprises the following main components by mass percent: 5.2 wt. %-6.0 wt. % of Al, 6.2 wt. %-12.5 wt. % of Zr, 5.8 wt. %-6.5 wt. % of Sn, 0.3 wt. %-1.5 wt. % of Si and the balance of Ti element, refractory metals and other unavoidable impurities; and the Ti alloy is composed of high Zr without C, B or rare earth elements, which is different in elements from the existing high-temperature Ti alloys.

The refractory metals include but are not limited to one of Mo, Nb, Ta and W which can be added singly or simultaneously, the mass percent of each element is 0.4 wt. %-6.5 wt. %, and the total amount of the refractory metals is less than 15 wt. %.

The quality purity of Ti, Al, Sn, Zr, Si and refractory metals is not lower than 99.9%.

The high-temperature ultra-high strength Ti alloy has good high-temperature strengths and plasticity in the as-cast state, the ultimate tensile strength not lower than 1 GPa at 600° C., the plasticity not lower than 10%, the temperature resistance performance close to the level of Ni-based superalloys and the density of only 4.7 g·cm⁻³, and can be used as the preferred material for high-temperature structural components.

In addition, the present invention also provides a preparation method for a 600° C./1 GPa high-temperature ultra-high strength Ti alloy, comprising the following steps:
Step 1: incoming materials quality inspection
Checking the surface quality, surface finish and oxidation states of raw materials;
Step 2: alloy formulation
Calculating the mass of each component, measuring the mass of each element according to the ratio, and storing the formulated alloy in a vacuum drying dish with the vacuum degree not lower than 15 psi;
Step 3: prefabrication of high-melting point master alloy
Carrying out vacuum arc melting of high-melting point elements and a certain amount of Ti, repeating melting for 3-5 times so that the alloy elements are completely melted into alloy liquid, then carrying out 5-min to 8-min electromagnetic stirring and mixing of the alloy liquid, and conducting furnace cooling to room temperature to obtain a prefabricated high-melting point master alloy; the high-melting point elements are Zr, Si and refractory metals; and the mass percent of a certain amount of Ti is 15%-30% of the total mass of the high-melting point elements;
Step 4: prefabrication of low-melting point Al—Sn master alloy
Carrying out vacuum arc melting of low-melting point elements Al and Sn, repeating melting for 2-3 times so that the alloy elements are completely melted into alloy liquid, then carrying out 2-min to 5-min electromagnetic stirring and mixing of the alloy liquid, and conducting furnace cooling to room temperature to obtain a prefabricated low-melting point Al—Sn master alloy;
Step 5: alloy preparation
Placing the prefabricated high-melting point master alloy obtained in step 3 and the prefabricated low-melting point Al—Sn master alloy obtained in step 4 in the middle position of Ti for vacuum arc melting, repeating melting for 3-5 times so that the master alloy is completely melted into alloy liquid, then carrying out 5-min to 8-min electromagnetic stirring and mixing of the alloy liquid, and conducting furnace cooling to room temperature to obtain a high-temperature ultra-high strength Ti alloy. The master alloys prefabricated in step 3 and step 4 can inhibit the uneven dissolution of elements and improve the microstructure homogeneity.
Step 6: microstructure analysis and properties testing
Carrying out microstructure analysis and mechanical properties testing of the high-temperature ultra-high strength Ti alloy.

The design principles and innovation of the present invention are analyzed as follows: with the above technical solution, the alloy composition is designed according to the cluster formula model which gives chemical short-range-order structural units and corresponding composition formulas. The alloy elements are first combined with the matrix Ti element to construct stabilized solid-solution structural units. The present invention parses the cluster composition formulas of mature industrial high-temperature Ti alloys and obtains α- and β-phase cluster formula structural units: α-[Al—Ti₁₂](AlTi₂) and β-[Al—(Ti,Zr)₁₄](Mo,Si,Nb,Ta,W)₁Sn₁T₁₁ which are centered by one Al atom and nearest-neighbored by Ti atom, and the ratio of the two cluster structural units is 12:5-14:3. The introduction of the α and β composition formulas and the respective alloying of the two phases can fully cover all kinds of Ti alloys including a Ti alloy, α+β dual-phase Ti and β Ti alloy, which provides a new design basis for the understanding of the existing Ti alloys and even the development of high-temperature ultra-high strength Ti alloy compositions.

A process for designing a 600° C./1 GPa high-temperature ultra-high strength Ti alloy in the present invention is as follows:
1) To increase the high-temperature strengths of the alloy, the main alloying elements are Al, Si, Sn and Zr, Al can improve the anti-oxidation performance of the alloy, Si can improve the high-temperature creep resistance of the alloy, and Sn can reduce the high-temperature hydrogen embrittlement sensitivity; the Zr element is completely solid solution in α and β phases, which can improve the high-temperature strengths of the alloy by solid solution strengthening; however, the content of the Al element exceeds 6.0 wt. %, which is easy to form brittle-phase Ti₃Al, resulting in reduction of alloy plasticity; the content of the Si element exceeds 1.5 wt. %, which is easy to form bulky silicides, resulting in reduction of alloy plasticity; the content of the Sn element exceeds 6.5 wt. %, which is easy to form brittle phases, resulting in reduction of alloy plasticity; and the content of the Zr element exceeds 12.5 wt. %, resulting in reduction of the anti-oxidation performance of the alloy;
3) To increase the melt thermal stability and plasticity of the alloy, the main alloying elements are refractory metals such as Ta, W, Nb and Mo, and the refractory metals can improve the melt thermal stability and have a body-centered-cubic crystal structure and multiple slip systems, which can increase the plasticity; however, the content of a single refractory metal exceeds 6.5 wt. % or the total amount of the refractory metals exceed 15 wt. %, which is easy to produce brittle phases and alloy spots.
4) By changing the ratios of Ti, Al, Sn, Zr, Si and refractory metals in the cluster formula, the optimum multi-component alloying effect is obtained, and the melt thermal stability is optimized. Finally, the high-temperature ultra-high strength Ti alloy is determined to comprise the follow main components by mass percent: 5.2 wt. %-6.0 wt. % of Al, 6.2 wt. %-12.5 wt. % of Zr, 5.8 wt. %-6.5 wt. % of Sn, 0.3 wt. %-1.5 wt. % of Si and the balance of Ti element, refractory metals and other unavoidable impurities; and the refractory metals include but are not limited to one of Mo, Nb, Ta and W which can be added singly or simultaneously, the mass percent of each element is 0.4 wt. %-6.5 wt. %, and the total amount of the refractory metals is less than 15 wt. %.

In the invention CN104018027A, the Institute of Metal Research, Chinese Academy of Sciences proposes a Ti65 high-temperature Ti alloy comprising the following components by mass percent: 5.4 wt. %-6.3 wt. % of Al, 2.5 wt. %-6.4 wt. % of Zr, 3 wt. %-5 wt. % of Sn, 0.0 wt. %-0.96 wt. % of Mo, 0.2 wt. %-0.5 wt. % of Nb, 0.3 wt. %-3.4 wt. % of Ta, 0.2 wt. %-1.6 wt. % of W, 0.25 wt. %-0.5 wt. % of Si, 0.0 wt. %-0.07 wt. % of C, O≤0.17 wt. %, Fe≤0.03 wt. % and the balance of Ti element and other unavoidable impurities. The 600° C./1 GPa high-temperature ultra-high strength Ti alloy of the present invention has the following three differences from the reference patent: 1) the alloying elements are different in type, and do not contain C element which is easy to cause uneven microstructure and high-temperature brittleness; 2) high Zr produces a strong solid solution strengthening effect and shows better high-temperature strengths; and 2) the range of the Sn element will exceed that of the reference patent.

The present invention has the following beneficial effects:
1) The present invention provides a 600° C./1 GPa high-temperature ultra-high strength Ti alloy, which comprises the following main components by mass percent: 5.2 wt. %-6.0 wt. % of Al, 6.2 wt. %-12.5 wt. % of Zr, 5.8 wt. %-6.5 wt. % of Sn and 0.3 wt. %-1.5 wt. % of Si, which can enhance the high-temperature strengths of the alloy, and 0.4 wt. %-6.5 wt. % of refractory metals that can be added separately or simultaneously and have the total amount less than 15 wt. %, which can enhance the melt thermal stability and plasticity; the master alloys are prefabricated, which can inhibit the uneven dissolution of elements and improve the microstructure homogeneity; 3) the characteristic is high Zr, and no C, B or rare-earth elements which are easy to cause microstructure heterogeneity and high-temperature brittleness. The present invention has the following typical performance indexes in the as-cast state: at 600° C., the ultimate tensile strength is not lower than 1 GPa, the plasticity is not lower than 10% and close to the level of Ni-based superalloys, the density is only 4.7 g·cm⁻³, and the 600° C./1 GPa high-temperature ultra-high strength Ti alloy has good high-temperature strengths and plasticity, high damage tolerance, high reliability and low cost, is convenient for mass production and can be used as an alternative material for high-temperature structural components of cutting-edge aviation and weapon equipment.

### DESCRIPTION OF DRAWINGS

FIG. 1 is a schematic diagram of an electromagnetic stirring system device for preparation of prefabricated master alloys and the final alloys in step 3 to step 5 in embodiment 1;

FIG. 2 is an optical microstructure diagram of a high-temperature ultra-high strength Ti alloy prepared in embodiment 2;

FIG. 3 is an optical microstructure diagram of a high-temperature ultra-high strength Ti alloy prepared in embodiment 3;

FIG. 4 is an optical microstructure diagram of Ti alloys prepared in reference example 2 and not prepared into prefabricated master alloys.

In the figures: 1 sealed chamber, 2 robotic arm, 3 welder heat emitter, 4 tungsten electrode, 5 copper mold and 6 electromagnetic emitter.

### DETAILED DESCRIPTION

The technical solution of the present invention is further described in detail below in accordance with the accompanying drawings and embodiments.

The electromagnetic stirring system device for preparation of prefabricated master alloys and alloys in step 3 to step 5 in the present embodiment is shown in FIG. 1 and composed of a sealed room 1, a robotic arm 2, a welder heat emitter 3, a tungsten electrode 4, a copper mold 5 and an electromagnetic emitter 6; The robotic arm 2, the welder heat emitter 3, the tungsten electrode 4, the copper mold 5 and the electromagnetic emitter 6 are arranged in the sealed chamber 1, the welder heat emitter 3 is arranged on the lower end face of the robotic arm 2, sealed and slidably connected, the lower end face of the welder heat emitter 3 is fixed with the tungsten electrode 4, the copper mold 5 is arranged on the upper end face of the electromagnetic emitter 6, sealed and slidably connected, and the tungsten electrode 4 is located above the copper mold 5. A method for using the device is as follows: filling alloy elements in the copper mold 5, vacuuming the sealed chamber 1 and filling with argon, starting the welder heat emitter 3 to control the current of the tungsten electrode 4, heating and melting the alloy elements in the copper mold 5 by arc heat produced by the tungsten electrode 4 to make the alloy elements completely melted into a mixture, and starting the electromagnetic emitter 6 for electromagnetic stirring and mixing of the alloy liquid in the copper mold 5. The function of the copper mold 5 is to limit the downward flow of slurry during electromagnetic stirring. Argon is filled to prevent oxidation failure of materials and obtain prefabricated Ti alloy ingots. In the device, the robotic arm 2 is controlled by a program so that the welder heat emitter 3 and the tungsten electrode 4 can move synchronously.

### Embodiment 1

The present embodiment is a 600° C./1 GPa high-temperature ultra-high strength Ti alloy which comprises the following components by mass percent (wt. %): 5.4 wt. % of Al, 6.4 wt. % of Zr, 6.2 wt. % of Sn, 4.0 wt. % of Ta, 1.6 wt. % of W, 0.5 wt. % of Si and the balance of Ti element and other unavoidable impurities; the total amount of refractory metals is 5.6 wt. %; and the quality purity of Al, Sn, Zr, Ta, W, Si and Ti is 99.98%.

The present embodiment is a method for preparing a 600° C./1 GPa high-temperature ultra-high strength Ti alloy, which comprises the following specific steps:
Step 1: incoming materials quality inspection: the raw materials have qualified surface quality and qualified surface finish without oxidation;
Step 2: alloy formulation: calculating the mass of each component, measuring the mass of each element according to the ratio, and storing the formulated alloy in a vacuum drying dish with the vacuum degree of 20 psi;
Step 3: prefabrication of high-melting point master alloy: heating high-melting point elements and a certain amount of Ti to 3250° C. at 350° C./min for 15-min vacuum arc melting, repeating melting for 4 times so that the alloy elements are completely melted into alloy liquid, then carrying out 6-min electromagnetic stirring and mixing of the alloy liquid at 3250° C., and conducting furnace cooling to room temperature to obtain a prefabricated high-melting point master alloy; the high-melting point elements are Zr, Mo, Nb, Ta, W and Si; and the mass percent of a certain amount of Ti is 20% of the total mass of the high-melting point elements;
Step 4: prefabrication of low-melting point Al—Sn master alloy: heating low-melting point elements Al and Sn to 750° C. at 150° C./min for 10-min vacuum arc melting, repeating melting for 3 times so that the alloy elements are completely melted into alloy liquid, then carrying out 4-min electromagnetic stirring and mixing of the alloy liquid at 750° C., and conducting furnace cooling to room temperature to obtain a prefabricated low-melting point Al—Sn master alloy;
Step 5: alloy preparation: placing the prefabricated high-melting point master alloy obtained in step 3 and the prefabricated low-melting point Al—Sn master alloy in the middle position of Ti for heating to 2200° C. at 350° C./min for 15-min vacuum arc melting, repeating melting for 4 times so that the alloy block is completely melted into alloy liquid, then carrying out 6-min electromagnetic stirring and mixing of the alloy liquid at 2200° C., and conducting furnace cooling to room temperature to obtain a high-temperature ultra-high strength Ti alloy.
Step 6: microstructure analysis and properties testing: carrying out microstructure analysis and mechanical properties testing of the high-temperature ultra-high strength Ti alloy.

### Embodiment 2

The present embodiment is a 600° C./1 GPa high-temperature ultra-high strength Ti alloy which comprises the following components by mass percent (wt. %): 6.0 wt. % of Al, 12.5 wt. % of Zr, 6.5 wt. % of Sn, 6.5 wt. % of Mo, 6.5 wt. % of Ta, 1.5 wt. % of Si and the balance of Ti element and other unavoidable impurities; the total amount of refractory metals is 13 wt. %; and the quality purity of Al, Sn, Zr, Mo, Ta, Si and Ti is 99.98%.

The present embodiment is a method for preparing a 600° C./1 GPa high-temperature ultra-high strength Ti alloy, which comprises the following specific steps:
Step 1: incoming materials quality inspection: the raw materials have qualified surface quality and qualified surface finish without oxidation;
Step 2: alloy formulation: calculating the mass of each component, measuring the mass of each element according to the ratio, and storing the formulated alloy in a vacuum drying dish with the vacuum degree of 20 psi;
Step 3: prefabrication of high-melting point master alloy: heating high-melting point elements and a certain amount of Ti to 3100° C. at 320° C./min for 12-min vacuum arc melting, repeating melting for 5 times so that the alloy elements are completely melted into alloy liquid, then carrying out 8-min electromagnetic stirring and mixing of the alloy liquid at 3100° C., and conducting furnace cooling to room temperature to obtain a prefabricated high-melting point master alloy; the high-melting point elements are Zr, Mo, Nb, Ta, W and Si; and the mass percent of a certain amount of Ti is 20% of the total mass of the high-melting point elements;
Step 4: prefabrication of low-melting point Al—Sn master alloy: heating low-melting point elements Al and Sn to 720° C. at 120° C./min for 8-min vacuum arc melting, repeating melting for 4 times so that the alloy elements are completely melted into alloy liquid, then carrying out 3-min electromagnetic stirring and mixing of the alloy liquid at 720° C., and conducting furnace cooling to room temperature to obtain a prefabricated low-melting point Al—Sn master alloy;
Step 5: alloy preparation: placing the prefabricated high-melting point master alloy obtained in step 3 and the prefabricated low-melting point Al—Sn master alloy in the middle position of Ti for heating to 2150° C. at 350° C./min for 10-min vacuum arc melting, repeating melting for 4 times so that the alloy block is completely melted into alloy liquid, then carrying out 10-min electromagnetic stirring and mixing of the alloy liquid at 2150° C., and conducting furnace cooling to room temperature to obtain a high-temperature ultra-high strength Ti alloy.
Step 6: microstructure analysis and properties testing: carrying out microstructure analysis and mechanical properties testing of the high-temperature ultra-high strength Ti alloy.

### Embodiment 3

The present embodiment is a 600° C./1 GPa high-temperature ultra-high strength Ti alloy which comprises the following components by mass percent (wt. %): 5.2 wt. % of Al, 6.2 wt. % of Zr, 5.8 wt. % of Sn, 0.4 wt. % of Mo, 1.2 wt. % of Nb, 0.4 wt. % of Ta, 0.4 wt. % of W, 0.3 wt. % of Si and the balance of Ti element and other unavoidable impurities; the total amount of refractory metals is 2.4 wt. %; and the quality purity of Al, Sn, Zr, Mo, Nb, Ta, W, Si and Ti is 99.98%.

The present embodiment is a method for preparing a 600° C./1 GPa high-temperature ultra-high strength Ti alloy, which comprises the following specific steps:
Step 1: incoming materials quality inspection: the raw materials have qualified surface quality and qualified surface finish without oxidation;
Step 2: alloy formulation: calculating the mass of each component, measuring the mass of each element according to the ratio, and storing the formulated alloy in a vacuum drying dish with the vacuum degree of 20 psi;
Step 3: prefabrication of high-melting point master alloy: heating high-melting point elements and a certain amount of Ti to 3200° C. at 350° C./min for 10-min vacuum arc melting, repeating melting for 5 times so that the alloy elements are completely melted into alloy liquid, then carrying out 10-min electromagnetic stirring and mixing of the alloy liquid at 3200° C., and conducting furnace cooling to room temperature to obtain a prefabricated high-melting point master alloy; the high-melting point elements are Zr, Mo, Nb, Ta, W and Si; and the mass percent of a certain amount of Ti is 20% of the total mass of the high-melting point elements;
Step 4: prefabrication of low-melting point Al—Sn master alloy: heating low-melting point elements Al and Sn to 730° C. at 130° C./min for 10-min vacuum arc melting, repeating melting for 3 times so that the alloy elements are completely melted into alloy liquid, then carrying out 5-min electromagnetic stirring and mixing of the alloy liquid at 730° C., and conducting furnace cooling to room temperature to obtain a prefabricated low-melting point Al—Sn master alloy;
Step 5: alloy preparation: placing the prefabricated high-melting point master alloy obtained in step 3 and the prefabricated low-melting point Al—Sn master alloy in the middle position of Ti for heating to 2350° C. at 350° C./min for 12-min vacuum arc melting, repeating melting for 4 times so that the alloy block is completely melted into alloy liquid, then carrying out 8-min electromagnetic stirring and mixing of the alloy liquid at 2350° C., and conducting furnace cooling to room temperature to obtain a high-temperature ultra-high strength Ti alloy.
Step 6: microstructure analysis and properties testing: carrying out microstructure analysis and mechanical properties testing of the high-temperature ultra-high strength Ti alloy.

### Reference Example 1

is different from embodiment 1 in that: the Ti alloy comprises the following components by mass percent (wt. %): 5.4 wt. % of Al, 0.5 wt. % of Zr, 6.2 wt. % of Sn, 0.5 wt. % of Si and the balance of Ti element and other unavoidable impurities, without refractory metals. Step 3 of prefabrication of high-melting point master alloy is not performed. Others are the same as those in embodiment 1. Reference example 2: is different from embodiment 2 in directly carrying out vacuum arc melting of the alloy elements instead of preparing prefabricated master alloys. Others are the same as those in embodiment 2.

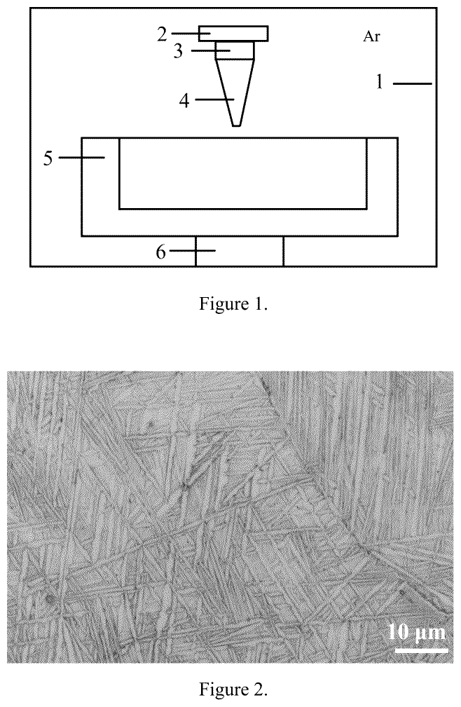

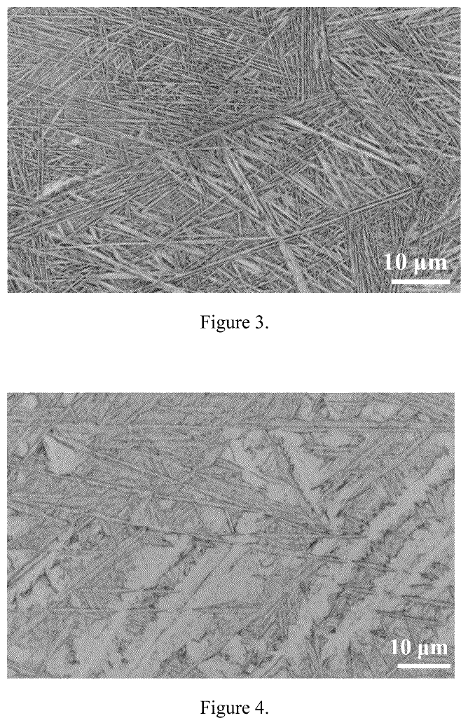

FIG. 2 is an optical microstructure diagram of a high-temperature ultra-high strength Ti alloy prepared in embodiment 2, and as shown in the figure, the microstructure of the sample is uniform and dense. FIG. 3 is an optical microstructure diagram of a high-temperature ultra-high strength Ti alloy prepared in embodiment 3, and as shown in the figure, the microstructure of the sample is uniform and dense. FIG. 4 is an optical microstructure diagram of Ti alloys prepared in reference example 2 and not prepared into prefabricated master alloys, and as shown in the figure, the microstructure of the sample is not uniform or dense and has micropores.

The tensile properties of ingots in embodiment 1 and reference example 1 are tested at different temperatures, and the data is shown in Table 1. It can be seen from Table 1 that the Ti alloy prepared in reference example 1 has the ultimate tensile strength of 1003 MPa, the yield strength of 955 MPa and the elongation of 3.2% at room temperature, has the ultimate tensile strength of 610 MPa, the yield strength of 580 MPa and the elongation of 8% at 600° C., has the ultimate tensile strength of 432 MPa, the yield strength of 396 MPa and the elongation of 10% at 650° C., and has the ultimate tensile strength of 360 MPa, the yield strength of 315 MPa and the elongation of 16% at 700° C.; and the high-temperature ultra-high strength Ti alloy prepared in embodiment 1 has the ultimate tensile strength of 1328 MPa, the yield strength of 1117 MPa and the elongation of 4.5% at room temperature; has the ultimate tensile strength of 1017 MPa, the yield strength of 936 MPa and the elongation of 11% at 600° C., has the ultimate tensile strength of 842 MPa, the yield strength of 793 MPa and the elongation of 18% at 650° C., and has the ultimate tensile strength of 640 MPa, the yield strength of 563 MPa and the elongation of 30% at 700° C. The ultimate tensile strength at room temperature of the high-temperature ultra-high strength Ti alloy prepared in embodiment 1 is 1.3 times that of the Ti alloy prepared in reference example 1; the ultimate tensile strength at 600° C. is 1.6 times that of the Ti alloy prepared in reference example 1; the ultimate tensile strength at 650° C. is 1.9 times that of the Ti alloy prepared in reference example 1; and the ultimate tensile strength at 700° C. is 1.7 times that of the Ti alloy prepared in reference example 1, and the elongation is 1.8 times that of the Ti alloy prepared in reference example 1. It can be seen that the high-temperature ultra-high strength Ti alloy prepared in embodiment 1 shows very sufficient high-temperature strengths and shaping, good damage tolerance and high reliability. Compared with the most commonly used industrial high-temperature Ti alloys Ti60 (with the ultimate tensile strength of 700 MPa, the yield strength of 584 MPa and the elongation of 14%, the following are tensile properties at 600° C.), IMI834 (with the ultimate tensile strength of 680 MPa, the yield strength of 550 MPa and the elongation of 15%) and Ti1100 (with the ultimate tensile strength of 630 MPa, the yield strength of 530 MPa and the elongation of 14%), the ultimate tensile strength at 600° C. of the high-temperature ultra-high strength Ti alloy prepared in embodiment 1 is increased by more than 45%, and the yield strength is increased by more than 60%.

Compared with a 600° C. high-temperature Ti alloy proposed by the patent CN113046595A, which has the ultimate tensile strength of 660 MPa and the yield strength of 570 MPa at 600° C., the ultimate tensile strength at 600° C. of the high-temperature ultra-high strength Ti alloy prepared in embodiment 1 is increased by more than 54%, and the yield strength is increased by more than 64%. Compared with a high-temperature Ti65 Ti alloy reported in literature, which has the ultimate tensile strength of 693 MPa, the yield strength of 558 MPa and the elongation of 18.4% at 650° C., the ultimate tensile strength at 650° C. of the high-temperature ultra-high strength Ti alloy prepared in embodiment 1 is increased by more than 21%, and the yield strength is increased by more than 42%. Compared with a 700° C. high-temperature-resistant Ti alloy proposed by the patent CN113249614A, which has the ultimate tensile strength of 536 MPa, the yield strength of 490 MPa and the elongation of 30.4% at 700° C., the ultimate tensile strength at 700° C. of the high-temperature ultra-high strength Ti alloy prepared in embodiment 1 is increased by more than 19%, the yield strength is increased by more than 17%, and the elongation is basically the same. At 600° C. and above, the alloy prepared in embodiment 1 has very excellent high-temperature strengths and reliability, the high-temperature ultimate tensile strength is close to the level of the most commonly used Ni-based superalloy GH4169, and the density of 4.7 g·cm⁻³ is much lower than that of the nickel-based superalloy of 8.3 g·cm⁻³, so the alloy can be used as the preferred material for high-temperature structural components.

Table 1 shows the tensile mechanical properties of embodiment 1, reference example 1, common high-temperature Ti alloys and the Ni-based superalloy GH4169 (National Standard: Manual of Aeronautical Materials).

| | | Ultimate Tensile | | | | | |
|---|---|---|---|---|---|---|---|
| Designation | Temperature | Strength | | Yield Strength | | Elongation | Density |
| Embodiment 1 | Room | 1328 | MPa | 1117 | MPa | 4.5% | 4.7 g · cm⁻³ |
| | temperature | | | | | | |
| | 600° C. | 1017 | MPa | 936 | MPa | 11% | 4.7 g · cm⁻³ |
| | 650° C. | 842 | MPa | 793 | MPa | 18% | 4.7 g · cm⁻³ |
| | 700° C. | 640 | MPa | 563 | MPa | 30% | 4.7 g · cm⁻³ |
| Reference | Room | 1003 | MPa | 955 | MPa | 3.2% | 4.6 g · cm⁻³ |
| example 1 | temperature | | | | | | |
| | 600° C. | 610 | MPa | 580 | MPa | 8% | 4.6 g · cm⁻³ |
| | 650° C. | 432 | MPa | 396 | MPa | 10% | 4.6 g · cm⁻³ |
| | 700° C. | 360 | MPa | 315 | MPa | 16% | 4.6 g · cm⁻³ |
| MI834 | Room | 1070 | MPa | 960 | MPa | 14% | 4.5 g · cm⁻³ |
| | temperature | | | | | | |
| | 600° C. | 680 | MPa | 550 | MPa | 15% | 4.5 g · cm⁻³ |
| Ti1100 | Room | 960 | MPa | 860 | MPa | 11% | 4.4 g · cm⁻³ |
| | temperature | | | | | | |
| | 600° C. | 630 | MPa | 530 | MPa | 14% | 4.4 g · cm⁻³ |
| Ti60 | Room | 1100 | MPa | 1030 | MPa | 11% | 4.5 g · cm⁻³ |
| | temperature | | | | | | |
| | 600° C. | 700 | MPa | 580 | MPa | 14% | 4.5 g · cm⁻³ |
| Ti600 | Room | 1068 | MPa | 1050 | MPa | 11% | 4.4 g · cm⁻³ |
| | temperature | | | | | | |
| | 600° C. | 745 | MPa | 615 | MPa | 16% | 4.4 g · cm⁻³ |
| Ti65 | Room | 1086 | MPa | 997 | MPa | 12% | 4.6 g · cm⁻³ |
| | temperature | | | | | | |
| | 650° C. | 693 | MPa | 558 | MPa | 18.4% | 4.6 g · cm⁻³ |
| GH4169 | Room | ≥1230 | MPa | ≥1020 | MPa | ≥6% | 8.3 g · cm⁻³ |
| | temperature | | | | | | |
| | 600° C. | ≥1140 | MPa | ≥1000 | MPa | ≥16% | 8.3 g · cm⁻³ |
| | 650° C. | ≥900 | MPa | ≥800 | MPa | ≥6% | 8.3 g · cm⁻³ |

The above embodiments only express the implementation of the present invention, and shall not be interpreted as a limitation to the scope of the patent for the present invention. It should be noted that, for those skilled in the art, several variations and improvements can also be made without departing from the concept of the present invention, all of which belong to the protection scope of the present invention.

1. A 600° C./1 GPa high-temperature ultra-high strength Ti alloy, wherein the Ti alloy belongs to an alloy system of Ti—Al—Zr—Sn—Si plus refractory metals and comprises the following main components by mass percent: 5.2 wt. %-6.0 wt. % of Al, 6.2 wt. %-12.5 wt. % of Zr, 5.8 wt. %-6.5 wt. % of Sn, 0.3 wt. %-1.5 wt. % of Si and the balance of Ti element, refractory metals and other unavoidable impurities; and the Ti alloy is composed of high Zr without C, B or rare earth elements;
wherein the refractory metals include but are not limited to one of Mo, Nb, Ta and W which can be added singly or simultaneously, the mass percent of each element is 0.4 wt. %-6.5 wt. %, and the total amount of the refractory metals is less than 15 wt. %;
wherein the high-temperature ultra-high strength Ti alloy has good high-temperature strengths and plasticity in the as-cast state, the ultimate tensile strengths not lower than 1 GPa at 600° C., the plasticity not lower than 10%, the temperature resistance performance close to the level of Ni-based superalloys and low density, and can be used as the preferred material for high-temperature structural components.

2. The 600° C./1 GPa high-temperature ultra-high strength Ti alloy according to claim 1, wherein the quality purity of Ti, Al, Sn, Zr, Si and refractory metals is not lower than 99.9%.

3. A preparation method for the 600° C./1 GPa high-temperature ultra-high strength Ti alloy of claim 1, comprising the following steps:
step 1: incoming materials quality inspection
checking the surface quality, surface finish and oxidation states of raw materials;
step 2: alloy formulation
calculating the mass of each component, measuring the mass of each element according to the ratio, and storing the formulated alloy in a vacuum drying dish with the vacuum degree not lower than 15 psi;
step 3: prefabrication of high-melting point master alloy
carrying out vacuum arc melting of high-melting point elements and Ti, carrying out electromagnetic stirring and mixing after the alloy elements are completely melted into alloy liquid, and then conducting furnace cooling to room temperature to obtain a prefabricated high-melting point master alloy; the high-melting point elements are Zr, Si and refractory metals; and the mass percent of Ti is 15%-30% of the total mass of the high-melting point elements;
step 4: prefabrication of low-melting point Al—Sn master alloy
carrying out vacuum arc melting of low-melting point elements Al and Sn, carrying out electromagnetic stirring and mixing after the alloy elements are completely melted into alloy liquid, and then conducting furnace cooling to room temperature to obtain a prefabricated low-melting point Al—Sn master alloy;
step 5: alloy preparation
placing the prefabricated high-melting point master alloy obtained in step 3 and the prefabricated low-melting point Al—Sn master alloy obtained in step 4 in the middle position of Ti for vacuum arc melting, carrying out electromagnetic stirring and mixing after the master alloy is completely melted into alloy liquid, and then conducting furnace cooling to room temperature to obtain a high-temperature ultra-high strength Ti alloy.
